(19) United States
(12) Patent Application Publication
(10) Pub. No.: US 2012/0185085 A1
(43) Pub. Date: Jul. 19, 2012

(54) CONVEYOR WITH DYNAMIC LOGICAL QUEUING

(76) Inventors: Martin Wentzel, Dallas, TX (US); Bengt Mueck, Irving, TX (US)

(21) Appl. No.: 13/006,508

(22) Filed: Jan. 14, 2011

(51) Int. Cl. G06F 7/00

(52) U.S. Cl. 700/230

(57) ABSTRACT

A system and method for dynamic logical queuing in a conveyor system. A method includes receiving a transport unit in a conveyor system having a series of physical conveyor units. The method includes determining a length of the transport unit by the conveyor system, and defining a logical conveyor unit corresponding to the transport unit according to the length of the transport unit. A plurality of the physical conveyor units is assigned to the logical conveyor unit. The method includes controlling the movement of the transport item through the conveyor system using the logical conveyor unit.

### TECHNICAL FIELD

The present disclosure is directed, in general, to conveyor systems for baggage, parcels, and other objects.

### BACKGROUND OF THE DISCLOSURE

Improved systems for transporting objects are desirable.

### SUMMARY OF THE DISCLOSURE

Various disclosed embodiments include a system and method. A method includes receiving a transport unit in a conveyor system having a series of physical conveyor units. The method includes determining a length of the transport unit by the conveyor system, and defining a logical conveyor unit corresponding to the transport unit according to the length of the transport unit. A plurality of the physical conveyor units is assigned to the logical conveyor unit. The method includes controlling the movement of the transport item through the conveyor system using the logical conveyor unit.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a system in which an embodiment can be implemented;

FIG. 2 shows a simplified block diagram of a conveyor system in accordance with disclosed embodiments; and

FIG. 3 depicts a flowchart of a simplified process in accordance with disclosed embodiments.

### DETAILED DESCRIPTION

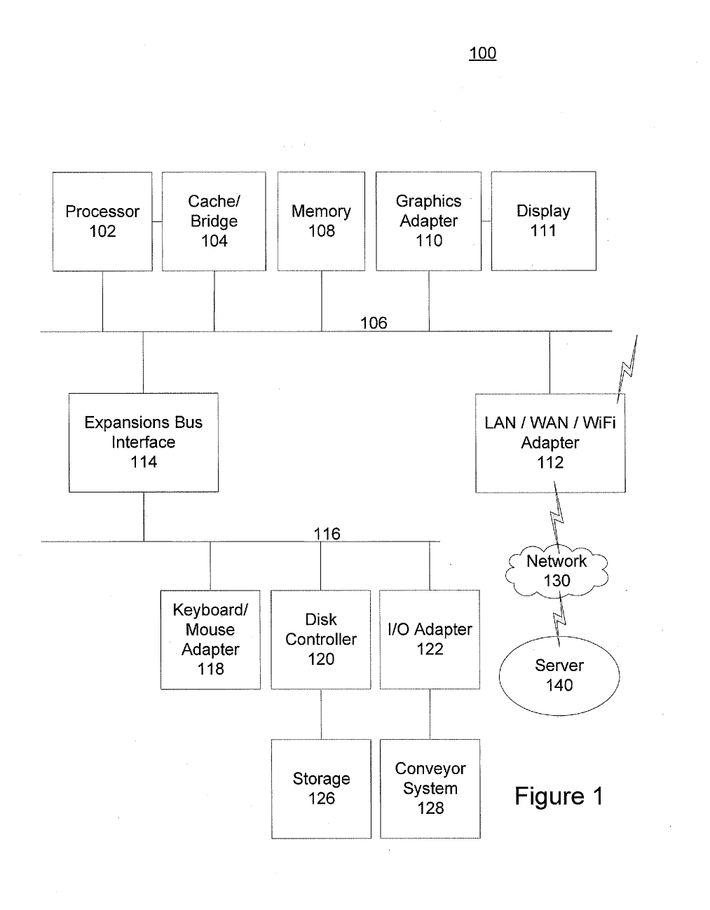

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods that can maintain a dynamic conveyor queue that provides advantages in space requirements and performance increases in places where the transport units of different sizes are buffered.

In baggage handling systems and other conveyor systems the size of different bags or transport items can vary significantly. The number of items that have dimensions that actually come close to the limits of the allowed range is very small.

In general, a conveyor system should be capable of transporting most or all transport items of varying sizes. In queued transport systems, including baggage handling systems, transport items that approach the upper limit acceptable sizes cause problems in the system design because the increasing length of the queue conveyors required to accommodate the length of the longest bags limits the flexibility and in some cases also the performance of the system.

In some systems, the length of the individual queue conveyors is designed to accommodate transport items up to a predetermined standard length. In most systems, including baggage transport systems, this will handle 90% of the items transported. For the rare cases when a transport item is longer than the standard length, two queue conveyors are logically combined to a longer conveyor.

In other cases, the length of the individual queue conveyors can be designed to accommodate transport all items anticipated to be conveyed. This approach can lead to a significant performance decrease since much space on each conveyor is wasted and the queue of transport items gets backed up.

Various embodiments include a system and method that dynamically senses the length of transport items and combines two or more smaller conveyors into a single logical conveyor appropriately sized for each transport item.

FIG. 1 depicts a block diagram of a system in which an embodiment can be implemented, for example as one of the systems or servers described below, and can be configured to perform processes as described herein. In particular embodiments, the system below can be implemented as a conveyor control system. The system depicted includes a controller such as processor 102, which can be implemented using any conventional general purpose processor, and in particular embodiments is implemented using a programmable logic controller (PLC) such as a SIEMENS SIMATIC Simatic S7 controller or an ALLEN-BRADLEY controller. In other cases, processor 102 can be implemented using programmable logic of any kind that is able to process signals/inputs and convert them to actions/outputs that then control the motion of the system as described herein.

Processor 102 can be connected a local system bus 106, or can be connected to a level two cache/bridge 104, which is connected in turn to a local system bus 106. Local system bus 106 may be, for example, a peripheral component interconnect (PCI) architecture bus or other common data bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. I/O adapter 122 can also be connected, in some embodiments, to a conveyor system 128, described in more detail below, that includes multiple physical conveyors configured to move transport items along one or more conveyor paths.

Keyboard/mouse adapter 118 provides a connection for a human interface device (not shown), such as a mouse, trackball, trackpointer, keyboard, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted, and other known elements of a conveyor system can be included to transport items or baggage as described herein or as known to those of skill in the art. The depicted example is provided for the purpose of explanation only and is not meant to imply architectural limitations with respect to the present disclosure.

LAN/WAN/Wireless adapter 112 can be connected to a network 130 (not a part of system 100), which can be any public or private data processing system network or combination of networks, as known to those of skill in the art, including the Internet. LAN/WAN/Wireless adapter 112 can also communicate with conveyor units as described herein, and perform other data processing system or server processes described herein. System 100 can, in some embodiments, communicate over network 130 with one or more server systems 140, which are also not part of data processing system 100, but can be implemented, for example, as separate systems 100.

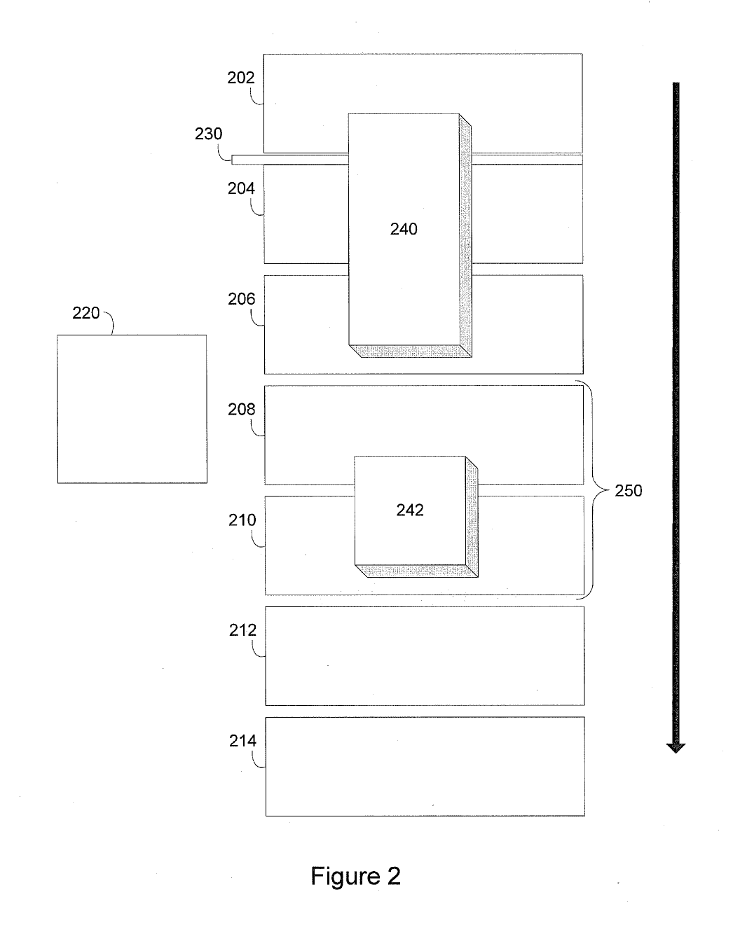

FIG. 2 shows a simplified block diagram of a conveyor system 200 in accordance with disclosed embodiments. Shown here are a plurality of conveyor units 202-214, each connected to be controlled by a conveyor control system 220 (connections omitted for clarity). The conveyor units 202-214 can be physically implemented using standard conveyors, and can be sized, for example, to have a transport length of approximately 50-60% of the length of the average item being transported. The arrow shows the direction of transport in this example.

A sensor 230, which can be implemented by a light sensor or otherwise, is connected to conveyor control system 220 to detect each transport item 240 and 242 that is transported by the conveyor units 202-214. In various embodiments, the sensor 230 can be implemented using one or more photo eyes, which can be used in combination with a pulse encoder. In some embodiments, each of the conveyor units 202-214 also includes a sensor 230.

The conveyor control system 220 determines the length of each transport item by use of sensor 230. In some cases, this can be based on the speed of conveyor units 202-214 and when the sensor 230 detects the leading end and trailing end of each transport item. In other cases, the length of each transport item can be detected by a single photo eye of the sensor 230 in combination with a pulse encoder, which together can be used to accurately measure the distance the belt has traveled while the photo eye detects the bag. Of course, in various embodiments, the length of the transport item can be detected by any other means that is known to the industry practitioner.

Based on the detected length of each transport item, the conveyor control system dynamically defines a plurality of the conveyor units 202-214 as a single logical conveyor unit for transporting that transport item. As that transport item is transported across the plurality of conveyor units 202-212, the conveyor control system dynamically assigns and de-assigns each individual conveyor unit to the logical conveyor unit to represent those conveyor units that are currently transporting the transport item.

The system can control the movement of the transport items based on the logical conveyor units, including adjusting the spacing between the various transport items by varying the speed of the logical conveyor units, moving or stopping specific logical conveyor units, and performing other conventional functions such as merging, sorting, and otherwise based on the logical conveyor units instead of individual physical conveyor units.

For example, in FIG. 2, a logical conveyor unit 250 is defined by the conveyor control system (at the time depicted) to include conveyor units 208 and 210, so that a first single logical conveyor unit 250 is assigned to transport item 242. Transport item 240 is crossing sensor 230, which has already detected its leading end of transport item 240 and will next detect the trailing end of transport item 240 as the trailing end passes over the sensor 230 and moves onto conveyor unit 204. At that time, transport item 240 will have moved so that it is being carried by conveyor units 204-208.

As described above, the conveyor control system determines the length of transport item 240, and that it extends over three of the conveyor units. The conveyor control system 220 defines a second logical conveyor unit corresponding to the transport item that includes three of the physical conveyor units, and initially assigns conveyor units 204-208 to the second logical conveyor unit.

At that time, transport item 242 will have also moved forward so that its front end is on conveyor unit 212 and its trailing end has moved off of conveyor unit 208 and onto conveyor unit 210. The conveyor control system maintains the first logical conveyor unit 250 to correspond to the position of the transport item 242 by de-assigning conveyor unit 208 to the first logical conveyor unit 250 and assigning conveyor unit 212 to the first logical conveyor unit 250. As described above, at the same time, conveyor unit 208 will be re-assigned to the second logical conveyor unit, corresponding to the updated position of transport item 240.

Although this simple example shows only a single straight-line set of conveyor units, those of skill in the art will recognize that the principles described herein apply to any conveyor system of various shapes, components, and configurations having multiple physical conveyor units, where the conveyor control system maintains logical conveyor units that each correspond to a transport item and one or more physical conveyor units. The defined logical conveyor units can be managed by the conveyor control system as conventional systems would manage individual physical conveyor units.

The disclosed techniques for dynamic queuing and management of logical conveyors can reduce the needed space and needed accelerations to close gaps between transport items. The use of smaller physical conveyors, grouped into logical conveyors, allow transport items of varying sizes to be placed on the conveyors more efficiently, shortening the required queue length for a given number of transport items, and allowing more precise control of the transport process. Due to the shortened gap between the transport items, use of the disclosed techniques upstream of merges will increase the throughput of the merged flow.

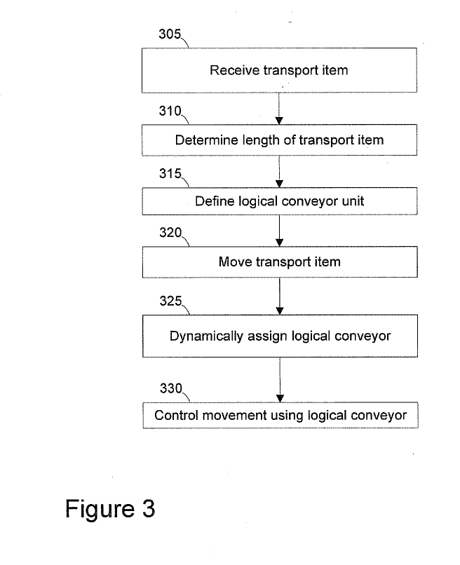

FIG. 3 depicts a flowchart of a simplified process in accordance with disclosed embodiments.

A transport item is received by a conveyor system (step 305). Receiving, in this context, can include the transport item being physically loaded or deposited onto the conveyor system, the transport item being moved to the conveyor system from another conveyor system or different part of the same conveyor system, or otherwise. The transport item can be, but is not limited to, luggage or other baggage. The conveyor system comprises a series of physical conveyor units. In some cases, the length of the transport surface of the physical conveyor units is approximately 50-60% of the length of the average transport item transported by the conveyor system.

The conveyor system determines the length of the transport item (step 310). This can be accomplished in some embodiments by sensing the front end and trailing end of the transport item and determining the length of the transport item therefrom. In some cases, the front end and trailing end of the transport item are sensed as the transport item is moved past a sensor, and the speed of the movement or distance of travel is also used in determining the length of the transport item.

Based on the length of the transport item, the conveyor system defines a logical conveyor unit corresponding to the transport item and a plurality of the physical conveyor units (step 315).

The conveyor system moves the transport item across the physical conveyor units (step 320).

As the transport item is moved across the physical conveyor units, the conveyor system, the conveyor system dynamically assigns and de-assigns individual ones of the physical conveyor units to the logical conveyor unit (step 325). In various embodiments, as the transport item moves onto a given physical conveyor unit, that physical conveyor unit is assigned to the logical conveyor unit. Similarly, in various embodiments, as the transport item moves off of a given physical conveyor unit, that physical conveyor unit is de-assigned from the logical conveyor unit.

The conveyor system controls the movement of the transport item through the conveyor system using the logical conveyor unit (step 330). This step can include performing queuing, merging, sorting, and other conveyor operations using multiple logical conveyor units each corresponding to a different transport item.

Those skilled in the art will recognize that, for simplicity and clarity, the full structure and operation of all systems suitable for use with the present disclosure is not being depicted or described herein. Instead, only so much of the physical systems as is unique to the present disclosure or necessary for an understanding of the present disclosure is depicted and described. The remainder of the construction and operation of the systems disclosed herein may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs). In particular, computer readable mediums can include transitory and non-transitory mediums, unless otherwise limited in the claims appended hereto.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
receiving a transport unit in a conveyor system having a series of physical conveyor units;
determining a length of the transport unit by the conveyor system;
defining a logical conveyor unit corresponding to the transport unit according to the length of the transport unit, a plurality of the physical conveyor units being assigned to the logical conveyor unit; and
controlling the movement of the transport item through the conveyor system using the logical conveyor unit.

2. The method of claim 1, further comprising dynamically assigning individual ones of the physical conveyor units to the logical conveyor unit as the transport item moves through the conveyor system.

3. The method of claim 1, further comprising dynamically de-assigning individual ones of the physical conveyor units from the logical conveyor unit as the transport item moves through the conveyor system.

4. The method of claim 1, wherein controlling the movement of the transport item includes performing a queuing operation using multiple logical conveyor units each corresponding to a different transport item.

5. The method of claim 1, wherein determining a length of the transport unit includes sensing a front end and a trailing end of the transport item and determining the length of the transport item therefrom.

6. The method of claim 1, wherein a length of a transport surface of each of the physical conveyor units is approximately 50-60% of a length of an average transport item transported by the conveyor system.

7. The method of claim 1, wherein the transport item is luggage.

8. A conveyor system, comprising:
a series of physical conveyor units; and
a conveyor control system connected to control the series of physical conveyor units, wherein the conveyor control system is configured to determine a length of a transport unit received by the conveyor system;
define a logical conveyor unit corresponding to the transport unit according to the length of the transport unit, a plurality of the physical conveyor units being assigned to the logical conveyor unit; and
control the movement of the transport item through the conveyor system using the logical conveyor unit.

9. The conveyor system of claim 8, the conveyor control system further configured to dynamically assign individual ones of the physical conveyor units to the logical conveyor unit as the transport item moves through the conveyor system.

10. The conveyor system of claim 8, the conveyor control system further configured to dynamically de-assign individual ones of the physical conveyor units from the logical conveyor unit as the transport item moves through the conveyor system.

11. The conveyor system of claim 8, wherein controlling the movement of the transport item includes performing a queuing operation using multiple logical conveyor units each corresponding to a different transport item.

12. The conveyor system of claim 8, wherein determining a length of the transport unit includes sensing a front end and a trailing end of the transport item and determining the length of the transport item therefrom.

13. The conveyor system of claim 8, wherein a length of a transport surface of each of the physical conveyor units is approximately 50-60% of a length of an average transport item transported by the conveyor system.

14. The conveyor system of claim 8, wherein the transport item is luggage.
